(19) United States
(12) Patent Application Publication
(10) Pub. No.: US 2025/0117815 A1
(43) Pub. Date: Apr. 10, 2025

(54) METHOD AND SYSTEM FOR FORECASTING MARKET ACTIVITY

(71) Applicant: JPMorgan Chase Bank, N.A., New York, NY (US)

(72) Inventors: William WATSON, Long Beach, NY (US); Naan CHO, New York, NY (US); Tucker Richard BALCH, Suwanee, GA (US); Manuela VELOSO, New York, NY (US); Jennifer ADAMSON, London (GB)

(73) Assignee: JPMorgan Chase Bank, N.A., New York, NY (US)

(21) Appl. No.: 18/377,116

(22) Filed: Oct. 5, 2023

(51) Int. Cl. G06Q 30/0202; G06F 40/40; G06Q 40/04

(52) U.S. Cl. CPC G06Q 30/0202; G06F 40/40; G06Q 40/04

(57) ABSTRACT

A method for using an artificial intelligence (AI) technique to forecast market activities by specific parties with respect to derivatives and other specific types of financial instruments is provided. The method includes: retrieving first information that relates to at least one form that corresponds to a government filing; generating, based on the first information, a first knowledge graph that relates to an entity, such as a commercial concern; retrieving second information that relates to historical actions performed by at least one person that is associated with the entity; and forecasting, based on the first knowledge graph and the second information, at least one proposed future transaction to be executed by the person with respect to the first entity. The forecasting is based on an application of an AI algorithm to the information retrieved from the government filing(s).

### CROSS-REFERENCE TO RELATED APPLICATIONS

This application is being filed concurrently on October __, 2023 with U.S. patent application Ser. No. ______ entitled “Method and System for Forecasting Trading Behavior and Thematic Concepts”; the contents of which are hereby incorporated by reference in its entirety.

### BACKGROUND

### 1. Field of the Disclosure

This technology generally relates to methods and systems for forecasting activities in markets, and more particularly to methods and systems for using an artificial intelligence technique to forecast market activities by specific parties with respect to derivatives and other specific types of financial instruments.

### 2. Background Information

The universe of derivatives presents unique challenges from a workflow automation and data management perspective in terms of achieving efficient position monitoring, optimized ecosystem management, and execution of trades. These challenges are spawned by a myriad of factors, including the inaccessibility of data, complex hierarchal reporting structures across different types of regulatory filings, and the intricate nature of derivatives as financial instruments.

The complex structure of derivatives as a financial instrument is reflected not only in its reporting structure within regulatory filings but also in the breadth of the data within different filings. In this regard, there is a myriad of different regulatory filings that houses unstructured intelligence on derivative instruments. It is virtually impossible for humans to read through, compare, or find intelligence at scale.

Accordingly, there is a need for a mechanism for using an artificial intelligence technique to forecast market activities by specific parties with respect to derivatives and other specific types of financial instruments.

### SUMMARY

The present disclosure, through one or more of its various aspects, embodiments, and/or specific features or sub-components, provides, inter alia, various systems, servers, devices, methods, media, programs, and platforms for methods and systems for an artificial intelligence technique to forecast market activities by specific parties with respect to derivatives and other specific types of financial instruments.

According to an aspect of the present disclosure, a method for forecasting market activity is provided. The method is implemented by at least one processor. The method includes: retrieving, by the at least one processor from an internet website, first information that relates to at least one form that corresponds to a government filing; generating, by the at least one processor based on the first information, a first knowledge graph that relates to a first entity; retrieving, by the at least one processor from a memory, second information that relates to historical actions performed by at least one person that is associated with the first entity; and forecasting, by the at least one processor based on the first knowledge graph and the second information, at least one proposed future transaction to be executed by the at least one person with respect to the first entity.

The forecasting may include applying, to the first knowledge graph, at least one artificial intelligence (AI) algorithm that is trained by using the second information.

The generating of the first knowledge graph may include using a Natural Language Processing (NLP) technique with respect to the at least one form.

The generating of the first knowledge graph may include applying at least one predetermined tree search algorithm to the first information.

The at least one form may be fileable with the federal government of the United States of America (USA) and may be publicly available and may include at least one from among a Form NPORT, a Form NMFP, a Form ADV, and a Form 13F.

The Form 13F may include at least one from among a Form 13F notice filing, a Form 13F combination report, and a Form 13F holdings report.

The at least one proposed future transaction may include a transaction that relates to at least one derivative financial instrument.

The at least one derivative financial instrument may include at least one from among a put option, a call option, a warrant, a swap, a futures contract, and an Equity Linked Notes instrument.

When an amendment to the at least one form is filed, the method may further include revising the first knowledge graph based on the amendment.

According to another exemplary embodiment, a computing apparatus for forecasting market activity is provided. The computing apparatus includes a processor; a memory; and a communication interface coupled to each of the processor and the memory. The processor is configured to: retrieve, from an internet website via the communication interface, first information that relates to at least one form that corresponds to a government filing; generate, based on the first information, a first knowledge graph that relates to a first entity; retrieve, from the memory, second information that relates to historical actions performed by at least one person that is associated with the first entity; and forecast, based on the first knowledge graph and the second information, at least one proposed future transaction to be executed by the at least one person with respect to the first entity.

The processor may be further configured to perform the forecasting by applying, to the first knowledge graph, at least one artificial intelligence (AI) algorithm that is trained by using the second information.

The processor may be further configured to generate the first knowledge graph by using an NLP technique with respect to the at least one form.

The processor may be further configured to generate the first knowledge graph by applying at least one predetermined tree search algorithm to the first information.

The at least one form may be fileable with the federal government of the USA and may be publicly available and may include at least one from among a Form NPORT, a Form NMFP, a Form ADV, and a Form 13F.

The Form 13F may include at least one from among a Form 13F notice filing, a Form 13F combination report, and a Form 13F holdings report.

The at least one proposed future transaction may include a transaction that relates to at least one derivative financial instrument.

The at least one derivative financial instrument may include at least one from among a put option, a call option, a warrant, a swap, a futures contract, and an Equity Linked Notes instrument.

When an amendment to the at least one form is filed, the processor may be further configured to revise the first knowledge graph based on the amendment.

According to yet another exemplary embodiment, a non-transitory computer readable storage medium storing instructions for forecasting market activity is provided. The storage medium includes a second set of executable code which, when executed by a processor, causes the processor to: retrieve, from an internet website, first information that relates to at least one form that corresponds to a government filing; generate, based on the first information, a first knowledge graph that relates to a first entity; retrieve, from a memory, second information that relates to historical actions performed by at least one person that is associated with the first entity; and forecast, based on the first knowledge graph and the second information, at least one proposed future transaction to be executed by the at least one person with respect to the first entity.

When executed by the processor, the executable code may further cause the processor to perform the forecasting by applying, to the first knowledge graph, at least one artificial intelligence (AI) algorithm that is trained by using the second information.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates an exemplary computer system.

FIG. 2 illustrates an exemplary diagram of a network environment.

FIG. 3 shows an exemplary system for implementing a method for using an artificial intelligence technique to forecast market activities by specific parties with respect to derivatives and other specific types of financial instruments.

FIG. 4 is a flowchart of an exemplary process for implementing a method for using an artificial intelligence technique to forecast market activities by specific parties with respect to derivatives and other specific types of financial instruments.

FIG. 5 is a diagram that illustrates a knowledge graph for a single fund that is usable in an execution of a method for using an artificial intelligence technique to forecast market activities by specific parties with respect to derivatives and other specific types of financial instruments, according to an exemplary embodiment.

FIG. 6 is a diagram that illustrates a workflow of a system that implements a method for using an artificial intelligence technique to forecast market activities by specific parties with respect to derivatives and other specific types of financial instruments, according to an exemplary embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in some examples include executable code that, when executed by one or more processors, cause the processors to carry out steps necessary to implement the methods of the examples of this technology that are described and illustrated herein.

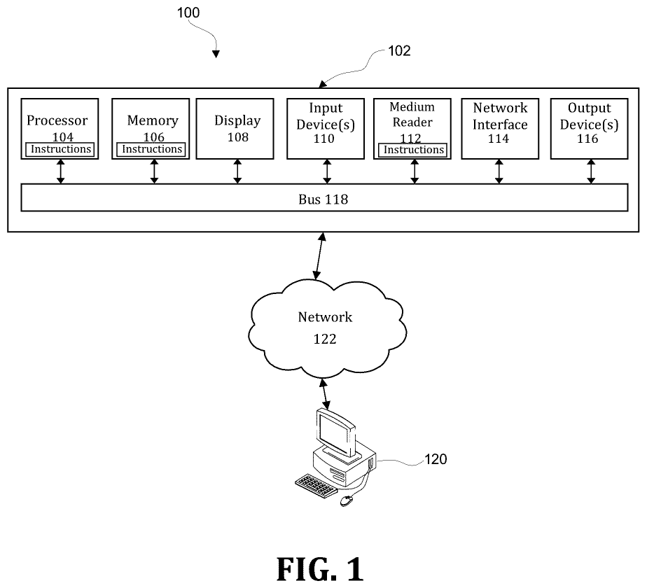

FIG. 1 is an exemplary system for use in accordance with the embodiments described herein. The system 100 is generally shown and may include a computer system 102, which is generally indicated.

The computer system 102 may include a set of instructions that can be executed to cause the computer system 102 to perform any one or more of the methods or computer-based functions disclosed herein, either alone or in combination with the other described devices. The computer system 102 may operate as a standalone device or may be connected to other systems or peripheral devices. For example, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning system (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term “system” shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 is tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 is an article of manufacture and/or a machine component. The processor 104 is configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that can store data as well as executable instructions and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions can be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, blu-ray disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid state display, a cathode ray tube (CRT), a plasma display, or any other type of display, examples of which are well known to skilled persons.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a GPS device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which is configured to read any one or more sets of instructions, e.g. software, from any of the memories described herein. The instructions, when executed by a processor, can be used to perform one or more of the methods and processes as described herein. In a particular embodiment, the instructions may reside completely, or at least partially, within the memory 106, the medium reader 112, and/or the processor 110 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote-control output, a printer, or any combination thereof.

Each of the components of the computer system 102 may be interconnected and communicate via a bus 118 or other communication link. As illustrated in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, for example, Bluetooth, Zigbee, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is illustrated in FIG. 1 as a wireless network, those skilled in the art appreciate that the network 122 may also be a wired network.

The additional computer device 120 is illustrated in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that is capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. For example, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In accordance with various embodiments of the present disclosure, the methods described herein may be implemented using a hardware computer system that executes software programs. Further, in an exemplary, non-limited embodiment, implementations can include distributed processing, component/object distributed processing, and parallel processing. Virtual computer system processing can be constructed to implement one or more of the methods or functionalities as described herein, and a processor described herein may be used to support a virtual processing environment.

As described herein, various embodiments provide optimized methods and systems for using an artificial intelligence technique to forecast market activities by specific parties with respect to derivatives and other specific types of financial instruments.

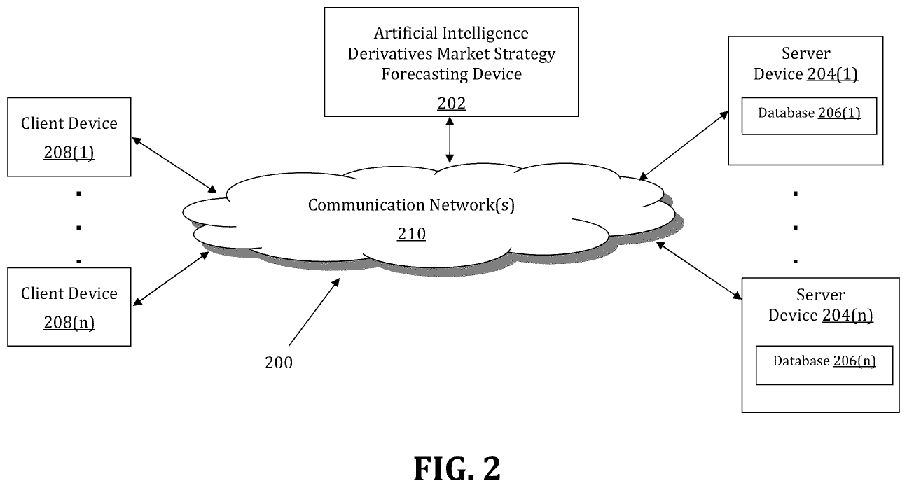

Referring to FIG. 2, a schematic of an exemplary network environment 200 for implementing a method for using an artificial intelligence technique to forecast market activities by specific parties with respect to derivatives and other specific types of financial instruments is illustrated. In an exemplary embodiment, the method is executable on any networked computer platform, such as, for example, a personal computer (PC).

The method for using an artificial intelligence technique to forecast market activities by specific parties with respect to derivatives and other specific types of financial instruments may be implemented by an Artificial Intelligence Derivatives Market Strategy Forecasting (AIDMSF) device 202. The AIDMSF device 202 may be the same or similar to the computer system 102 as described with respect to FIG. 1. The AIDMSF device 202 may store one or more applications that can include executable instructions that, when executed by the AIDMSF device 202, cause the AIDMSF device 202 to perform actions, such as to transmit, receive, or otherwise process network messages, for example, and to perform other actions described and illustrated below with reference to the figures. The application(s) may be implemented as modules or components of other applications. Further, the application(s) can be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the AIDMSF device 202 itself, may be located in virtual server(s) running in a cloud-based computing environment rather than being tied to one or more specific physical network computing devices. Also, the application(s) may be running in one or more virtual machines (VMs) executing on the AIDMSF device 202. Additionally, in one or more embodiments of this technology, virtual machine(s) running on the AIDMSF device 202 may be managed or supervised by a hypervisor.

In the network environment 200 of FIG. 2, the AIDMSF device 202 is coupled to a plurality of server devices 204(1)-204(n) that hosts a plurality of databases 206(1)-206(n), and also to a plurality of client devices 208(1)-208(n) via communication network(s) 210. A communication interface of the AIDMSF device 202, such as the network interface 114 of the computer system 102 of FIG. 1, operatively couples and communicates between the AIDMSF device 202, the server devices 204(1)-204(n), and/or the client devices 208(1)-208(n), which are all coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the AIDMSF device 202, the server devices 204(1)-204(n), and/or the client devices 208(1)-208(n) may be coupled together via other topologies. Additionally, the network environment 200 may include other network devices such as one or more routers and/or switches, for example, which are well known in the art and thus will not be described herein. This technology provides a number of advantages including methods, non-transitory computer readable media, and AIDMSF devices that efficiently implement a method for using an artificial intelligence technique to forecast market activities by specific parties with respect to derivatives and other specific types of financial instruments.

By way of example only, the communication network(s) 210 may include local area network(s) (LAN(s)) or wide area network(s) (WAN(s)), and can use TCP/IP over Ethernet and industry-standard protocols, although other types and/or numbers of protocols and/or communication networks may be used. The communication network(s) 210 in this example may employ any suitable interface mechanisms and network communication technologies including, for example, teletraffic in any suitable form (e.g., voice, modem, and the like), Public Switched Telephone Network (PSTNs), Ethernet-based Packet Data Networks (PDNs), combinations thereof, and the like.

The AIDMSF device 202 may be a standalone device or integrated with one or more other devices or apparatuses, such as one or more of the server devices 204(1)-204(n), for example. In one particular example, the AIDMSF device 202 may include or be hosted by one of the server devices 204(1)-204(n), and other arrangements are also possible. Moreover, one or more of the devices of the AIDMSF device 202 may be in a same or a different communication network including one or more public, private, or cloud networks, for example.

The plurality of server devices 204(1)-204(n) may be the same or similar to the computer system 102 or the computer device 120 as described with respect to FIG. 1, including any features or combination of features described with respect thereto. For example, any of the server devices 204(1)-204(n) may include, among other features, one or more processors, a memory, and a communication interface, which are coupled together by a bus or other communication link, although other numbers and/or types of network devices may be used. The server devices 204(1)-204(n) in this example may process requests received from the AIDMSF device 202 via the communication network(s) 210 according to the HTTP-based and/or JavaScript Object Notation (JSON) protocol, for example, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that are configured to store historical market data and data that relates to regulatory filings.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

The server devices 204(1)-204(n) may operate as a plurality of network computing devices within a cluster architecture, a peer-to peer architecture, virtual machines, or within a cloud architecture, for example. Thus, the technology disclosed herein is not to be construed as being limited to a single environment and other configurations and architectures are also envisaged.

The plurality of client devices 208(1)-208(n) may also be the same or similar to the computer system 102 or the computer device 120 as described with respect to FIG. 1, including any features or combination of features described with respect thereto. For example, the client devices 208(1)-208(n) in this example may include any type of computing device that can interact with the AIDMSF device 202 via communication network(s) 210. Accordingly, the client devices 208(1)-208(n) may be mobile computing devices, desktop computing devices, laptop computing devices, tablet computing devices, virtual machines (including cloud-based computers), or the like, that host chat, e-mail, or voice-to-text applications, for example. In an exemplary embodiment, at least one client device 208 is a wireless mobile communication device, i.e., a smart phone.

The client devices 208(1)-208(n) may run interface applications, such as standard web browsers or standalone client applications, which may provide an interface to communicate with the AIDMSF device 202 via the communication network(s) 210 in order to communicate user requests and information. The client devices 208(1)-208(n) may further include, among other features, a display device, such as a display screen or touchscreen, and/or an input device, such as a keyboard, for example.

Although the exemplary network environment 200 with the AIDMSF device 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as will be appreciated by those skilled in the relevant art(s).

One or more of the devices depicted in the network environment 200, such as the AIDMSF device 202, the server devices 204(1)-204(n), or the client devices 208(1)-208(n), for example, may be configured to operate as virtual instances on the same physical machine. In other words, one or more of the AIDMSF device 202, the server devices 204(1)-204(n), or the client devices 208(1)-208(n) may operate on the same physical device rather than as separate devices communicating through communication network(s) 210. Additionally, there may be more or fewer AIDMSF devices 202, server devices 204(1)-204(n), or client devices 208(1)-208(n) than illustrated in FIG. 2.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

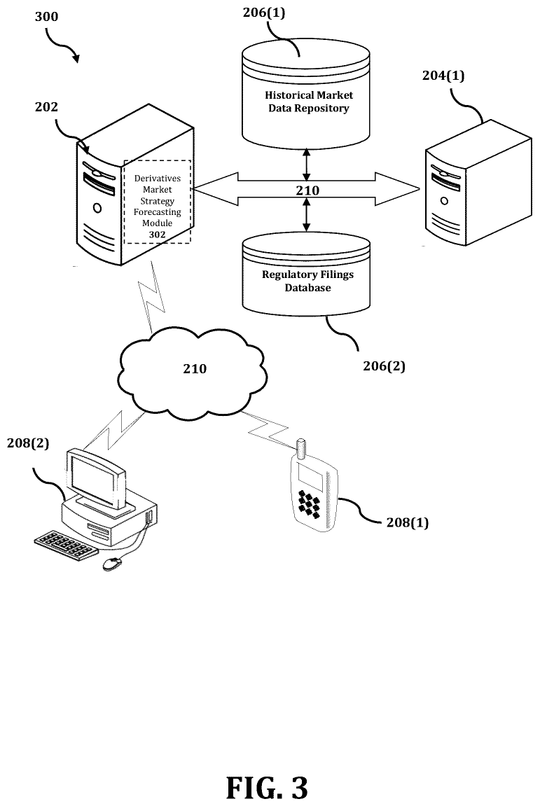

The AIDMSF device 202 is described and illustrated in FIG. 3 as including a derivatives market strategy forecasting module 302, although it may include other rules, policies, modules, databases, or applications, for example. As will be described below, the derivatives market strategy forecasting module 302 is configured to implement a method for using an artificial intelligence technique to forecast market activities by specific parties with respect to derivatives and other specific types of financial instruments.

An exemplary process 300 for implementing a mechanism for using an artificial intelligence technique to forecast market activities by specific parties with respect to derivatives and other specific types of financial instruments by utilizing the network environment of FIG. 2 is illustrated as being executed in FIG. 3. Specifically, a first client device 208(1) and a second client device 208(2) are illustrated as being in communication with AIDMSF device 202. In this regard, the first client device 208(1) and the second client device 208(2) may be “clients” of the AIDMSF device 202 and are described herein as such. Nevertheless, it is to be known and understood that the first client device 208(1) and/or the second client device 208(2) need not necessarily be “clients” of the AIDMSF device 202, or any entity described in association therewith Any additional or alternative relationship may exist between either or both of herein. the first client device 208(1) and the second client device 208(2) and the AIDMSF device 202, or no relationship may exist.

Further, AIDMSF device 202 is illustrated as being able to access a historical market data repository 206(1) and a regulatory filings database 206(2). The derivatives market strategy forecasting module 302 may be configured to access these databases for implementing a method for using an artificial intelligence technique to forecast market activities by specific parties with respect to derivatives and other specific types of financial instruments.

The first client device 208(1) may be, for example, a smart phone. Of course, the first client device 208(1) may be any additional device described herein. The second client device 208(2) may be, for example, a personal computer (PC). Of course, the second client device 208(2) may also be any additional device described herein.

The process may be executed via the communication network(s) 210, which may comprise plural networks as described above. For example, in an exemplary embodiment, either or both of the first client device 208(1) and the second client device 208(2) may communicate with the AIDMSF device 202 via broadband or cellular communication. Of course, these embodiments are merely exemplary and are not limiting or exhaustive.

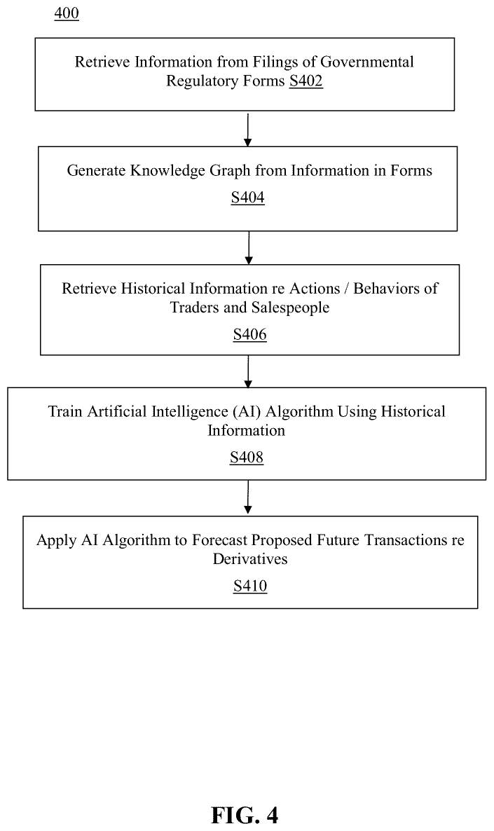

Upon being started, the derivatives market strategy forecasting module 302 executes a process for using an artificial intelligence technique to forecast market activities by specific parties with respect to derivatives and other specific types of financial instruments. An exemplary process for using an artificial intelligence technique to forecast market activities by specific parties with respect to derivatives and other specific types of financial instruments is generally indicated at flowchart 400 in FIG. 4.

In process 400 of FIG. 4, at step S402, the derivatives market strategy forecasting module 302 retrieves first information that relates to at least one form that corresponds to a government filing. In an exemplary embodiment, each such form is fileable with the federal government of the United States of America and is publicly available via the internet. For example, the form(s) may include forms that are required for filing with the Securities and Exchange Commission (SEC), such as, for example, a Form NPORT, a Form NMMFP, a Form ADV, and/or a Form 13F. Further, the Form 13F may include any one or more of a Form 13F notice filing, a Form 13F combination report, and/or a Form 13F holdings report.

At step S404, the derivatives market strategy forecasting module 302 uses the first information to generate a knowledge graph that relates to a particular entity, such as, for example, a corporate concern. In an exemplary embodiment, the derivatives market strategy forecasting module 302 uses a Natural Language Processing (NLP) technique with respect to the first information retrieved in step S402 during the process of generating the knowledge graph. In an exemplary embodiment, the derivatives market strategy forecasting module 302 applies a predetermined tree search algorithm to the first information in order to generate the knowledge graph.

At step S406, the derivatives market strategy forecasting module 302 retrieves, from a memory or a database, second information that relates to historical actions and/or behaviors performed by at least one person that is associated with the particular entity. In an exemplary embodiment, the person may be a trader, a broker, or a salesperson, and the historical actions may include executions of market-based transactions that relate to the particular entity.

At step S408, the derivatives market strategy forecasting module 302 uses the second information retrieved in step S406 to train a predetermined artificial intelligence (AI) algorithm that is designed to analyze trading and transactional patterns. Then, at step S410, the derivatives market strategy forecasting module 302 applies the AI algorithm to the knowledge graph generated in step S404 in order to forecast at least one proposed future transaction to be executed by the person with respect to the entity. In an exemplary embodiment, the proposed future transaction(s) relate to one or more derivative financial instruments, such as, for example, any or more of a put option, a call option, a warrant, a swap, a futures contract, and/or an Equity Linked Notes instrument.

In an exemplary embodiment, when an amendment to any of the forms discussed above is filed, the derivatives market strategy forecasting module 302 may revise the knowledge graph generated in step S404 based on the amendment. In this regard, when the knowledge graph is revised, the subsequent steps S406, S408, and S410 may be repeated in order to generate an updated forecast. In addition, as additional forms are filed over a period of time, the steps of the process 400 may be repeated on an as-needed basis in order to generate fresh forecasts.

The universe of derivatives presents unique challenges from a workflow automation and data management perspective in terms of achieving efficient position monitoring, optimized ecosystem management, and execution of trades. These challenges are spawned by a myriad of factors including the inaccessibility of data, complex hierarchal reporting structures across different types of regulatory filings, and the intricate nature of derivatives as financial instruments.

In an exemplary embodiment, an automated ecosystem referred to herein as “AIDerivSelect” monitors all derivatives in the EDGAR database by the Securities and Exchange Commission (SEC). The AIDerivSelect system is designed to leverage subject matter expertise to be permeated throughout the tool for workflow automation, and to use Natural Language Processing (NLP) and artificial intelligence (AI) techniques for memory preservation, knowledge graph construction, and citation analysis for the provision of derivatives intelligence at scale.

In an exemplary embodiment, the AIDerivSelect system is an end-to-end workflow automation tool and systematic architecture that encompasses, in real-time, the universe of all derivatives in the United States that are held by various entities, including funds governed by the Investment Company Act of 1940 and private funds such as hedge funds, private equity funds, or securitized asset funds. In particular, the AIDerivSelect system is an ecosystem that systematically and automatically designs an efficient workflow for analyzing all derivatives in U.S. regulatory filings on EDGAR. In this context, the AIDerivSelect system incorporates a salesperson's workflow in its minute details to design a comprehensive system that surfaces timely opportunities in the derivatives space. Secondly, the AIDerivSelect system leverages NLP techniques for document analysis to extract and ingest structured and unstructured data from the entirety of the EDGAR database. This process incorporates the inclusion of any type of notices, amendments, and feedback forms in a systematic manner. Thirdly, the AIDerivSelect system houses techniques that cross-reference documents across time, build a knowledge graph of complex relationships, and analyze hierarchy automatically for different data fields. These techniques are used for building a scalable architecture that systematically updates from not only EDGAR but also from the user's workflow.

The complex structure of derivatives as a financial instrument is reflected not only in its reporting structure within regulatory filings but also in the breadth of the data within different filings. Firstly, there is a myriad of different regulatory filings that houses unstructured intelligence on derivative instruments. In this aspect, the AIDerivSelect system is designed to analyze the entirety of the EDGAR database to systematically understand which regulatory filings house derivative intelligence. The entirety of the EDGAR universe amounts to 347,082 filings for the first quarter of 2023. It is virtually impossible for humans to read through, compare, or find intelligence at scale. In view of this volume, the AIDerivSelect system employs a combination of keyword search, entity recognition techniques, and most importantly, salespeople and traders' workflow processes to find Form NPORT, NMFP, ADV, and 13F for derivative intelligence in the most computationally efficient way.

Workflow Automation in Information Discovery: The AIDerivSelect system houses algorithms that have been trained on and learned from behaviors of salespeople and traders in terms of information discovery. In this context, information discovery is defined as the selection process by which the source of any kind of intelligence of derivatives is determined. Moreover, this learning process is comprehensive, in order to capture different types of derivative instruments such as options, warrants, swaps, futures contracts, or Equity Linked Notes.

In an exemplary embodiment, it is critical to understand the importance of amendments and notices within EDGAR. While certain types of filings can be filed on a quarterly or monthly basis, amendments can filed on an ad-hoc basis. As a result, the system includes an infrastructure that incorporates such amendments effectively, thereby avoiding a need to “reinvent the wheel” with each new amendment.

In an exemplary embodiment, the process of finding key documents, extracting key intelligence using NLP, incorporating amendments real-time, and structuring all relevant data into a digestible manner is achievable in less than 23 minutes.

Natural Language Processing (NLP) Techniques to Extract Form NPORT: Form NPORT is a quarterly filing that is released within 60 days after the end of the fund's fiscal quarter. It is a comprehensive filing that is required for reporting on every single one of a fund's monthly holdings. The filing is mandatory for registered investment companies, excluding money market funds, in accordance with the 1940 Investment Company Act. Every quarter, excluding amendments, approximately 15,217 filings are uploaded to EDGAR. In an exemplary embodiment, the AIDerivSelect system discovers these filings via intelligent entity recognition methods.

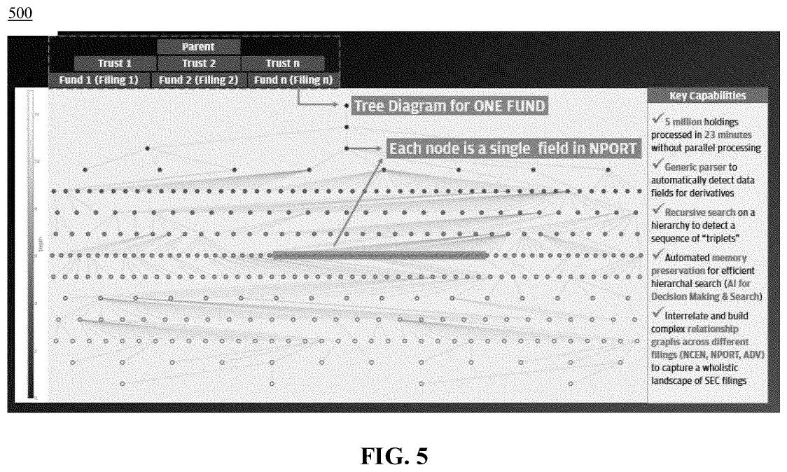

NPORT Knowledge Graphs—AI for Search, Memory Preservation, and Optimization in Multi-Dimensional Space: In an exemplary embodiment, the AIDerivSelect system employs key tree search algorithms to automatically generate knowledge graphs for any type of fund. These algorithms are generalizable and must be malleable to different types of hierarchal structures. FIG. 5 is a diagram 500 that illustrates a knowledge graph for a single fund that is usable in an execution of a method for using an artificial intelligence technique to forecast market activities by specific parties with respect to derivatives and other specific types of financial instruments, according to an exemplary embodiment.

Referring to FIG. 5, each node in diagram 500 represents a single data field within Form NPORT. While the representation in diagram 500 is two-dimensional, the actual dimensions of the knowledge graph include eight levels of hierarchy. This is due to the complex hierarchal structure within derivative instruments.

Since derivatives reflect the movement of an underlying instrument, whether of an equity or fixed-income product, the knowledge graph of one single derivative can delve into deeper dimensions. The composition of one single derivative may be made up of an entire index or basket of stocks.

Therefore, the importance of drawing out these complex knowledge graphs becomes paramount. One question or data field within Form NPORT cannot be analyzed on its own—it has to be analyzed in conjunction with the question or data field before, especially in the case of nested derivatives, i.e., derivatives in which the underlying instrument is itself a derivative.

In addition, knowledge graphs are key in incorporating amendments to original filings at scale. In this aspect, the AIDerivSelect system generates knowledge graphs for every single fund for a single point in time. When an amendment is filed, the system generates a knowledge graph that corresponds to the amendment and quickly contrasts the original filing's knowledge graph with that of the amendments. Subsequently, this search concludes with a “swapping out” of the amended data field. This process is optimized due to speedy construction of these knowledge graphs.

As a result, for an entire quarter's worth of NPORT forms, which amounts to approximately 5 million holdings, the AIDerivSelect system processes and ingests this data in less than 23 minutes.

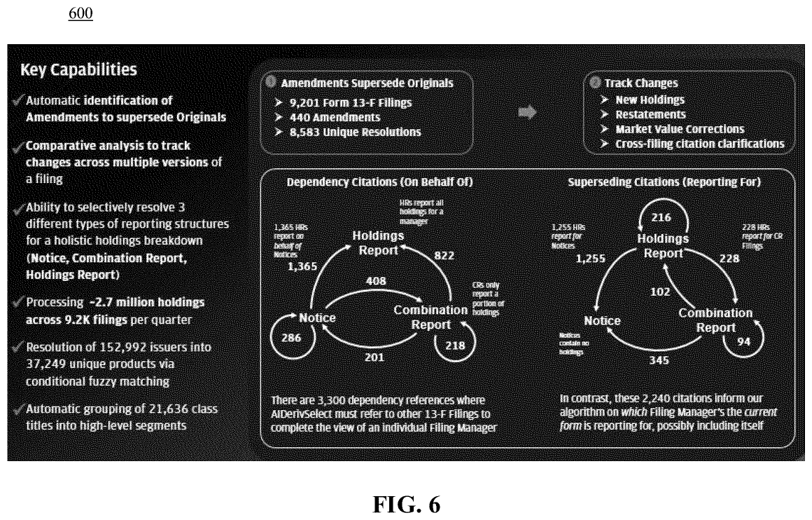

Citation Analysis to Understand Complex Relationships for Filing Managers in Form 13F: In an exemplary embodiment, workflow automation techniques have been used to discover the fact that Form 13F acts as a key source of derivative instruments. Form 13F captures the universe of options in the hedge fund space and is very complex in terms of its reporting structure. FIG. 6 is a diagram 600 that illustrates a workflow with respect to Form 13F of a system that implements a method for using an artificial intelligence technique to forecast market activities by specific parties with respect to derivatives and other specific types of financial instruments, according to an exemplary embodiment.

This is driven by the fact that Form 13F is actually a general term of three different types of filings, i.e., notices, combination reports, and holdings reports. In this context, it is very rare that one filing manager has one report. In an exemplary embodiment, the AIDerivSelect system has observed that in many cases, filing mangers reference or “cite” another filing manager on whose behalf a filing is to be completed. As an example, for the first quarter of 2023, the AIDerivSelect system has observed approximately 1,365 notices that reference another holdings report. This citation analysis is key, because such notices do not hold key intelligence in client holdings.

As a result, in an exemplary embodiment, referring again to FIG. 6, the AIDerivSelect system includes a citational architecture is designed to track, construct, and in many cases, predict the relationships of different documents at scale. The core architecture has the ability to selectively self-resolve and determine three different types of reporting structures and effectively categorize which filing manager files on behalf of another filings manager. In total, there are 3,300 dependency references to complete the view of an individual filing manager. By contrast, there are 2,240 citations that inform the algorithms on which filing manager the current form is reporting for, possibly including itself. In addition, resolving the citation relationships yields a network graph of co-filing entities. In an exemplary embodiment, the AIDerivSelect system can organize filers into related clusters by examining a clique structure of a filing manager relationship network. This may then be used to create a hierarchical representation of entities, with parent entities representing the clique cluster and filing entities as the individual vertices in the clique.

There is no one-to-one match in these dependency and citation relationships due to errors in the EDGAR system and also errors by the filing managers themselves. As a result, in an exemplary embodiment, the AIDerivSelect system includes an architecture that highlights such errors and self-resolves through prediction models in unsupervised learning. In an exemplary embodiment, the AIDerivSelect system automates the entire ingestion pipeline of Form 13F in just under 5 minutes.

Workflow Automation in Insight Generation by Leveraging AI to Learn from Behavior of Salespeople and Traders: In an exemplary embodiment, the AIDerivSelect system has the ability to predict a salesperson or trader's workflow by analyzing prior workflows. In this aspect, the AIDerivSelect system retrieves activity data to a user interface and analyzes how certain tools lead to the usage of another suite of tools.

As an example, the AIDerivSelect system observes that salespeople tend to analyze the wallet share for a subset of clients or prospects, i.e., asset manager A has X% wallet in over-the-counter (OTC) options in the United States. Then, salespeople may go into the individual derivative instruments that compose the remaining X% share of wallet (i.e., a share that is being managed by a competitor). This facilitates an understanding of this remaining share of wallet at a granular level, e.g., down to the individual stock components making up the basket. Finally, salespeople may access the expiry dates of that basket to understand optimal timing to call a client and have a competitive advantage over a competitor.

In an exemplary embodiment, the AIDerivSelect learns from this workflow, so that it automatically redirects a user to the next step by predicting user behavior. This enables efficient insight generation and predicts client behavior and competitor behavior that impacts bottom-line revenue. In addition, the AIDerivSelect system continuously updates its learning from user behavior in order to construct the most optimal method of surfacing opportunities.

As another example, consider the following: X% of Asset Manager A's wallet is in US swaps and all of this activity is being performed by a competitor Z. In an exemplary embodiment, in order to better understand the opportunity, the user may navigate within the AIDerivSelect system to identify what this business is. Using the information listed, an identification as to whether this activity is a Single Stock Swap, an Index Swap or a Custom Basket may be made. If, for example, it is a custom basket, the salesperson may then analyze the components of that basket in order to identify the theme and purpose of the clients' trading activity. Then, the salesperson may access the system to understand the maturity date of that basket to understand the optimal timing to call a client and pitch the optimized baskets.

Accordingly, with this technology, a process for using an artificial intelligence technique to forecast market activities by specific parties with respect to derivatives and other specific types of financial instruments is provided.

Although the invention has been described with reference to several exemplary embodiments, it is understood that the words that have been used are words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, methods, and uses such as are within the scope of the appended claims.

For example, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium can include a solid-state memory such as a memory card or other package that houses one or more non-volatile read-only memories. Further, the computer-readable medium can be a random-access memory or other volatile re-writable memory. Additionally, the computer-readable medium can include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, can be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards are periodically superseded by faster or more efficient equivalents having essentially the same functions. Accordingly, replacement standards and protocols having the same or similar functions are considered equivalents thereof.

The illustrations of the embodiments described herein are intended to provide a general understanding of the various embodiments. The illustrations are not intended to serve as a complete description of all the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims, and their equivalents, and shall not be restricted or limited by the foregoing detailed description.

What is claimed is:

1. A method for forecasting market activity, the method being implemented by at least one processor, the method comprising:
retrieving, by the at least one processor from an internet website, first information that relates to at least one form that corresponds to a government filing;
generating, by the at least one processor based on the first information, a first knowledge graph that relates to a first entity;
retrieving, by the at least one processor from a memory, second information that relates to historical actions performed by at least one person that is associated with the first entity; and
forecasting, by the at least one processor based on the first knowledge graph and the second information, at least one proposed future transaction to be executed by the at least one person with respect to the first entity.

2. The method of claim 1, wherein the forecasting comprises applying, to the first knowledge graph, at least one artificial intelligence (AI) algorithm that is trained by using the second information.

3. The method of claim 1, wherein the generating of the first knowledge graph comprises using a Natural Language Processing (NLP) technique with respect to the at least one form.

4. The method of claim 1, wherein the generating of the first knowledge graph comprises applying at least one predetermined tree search algorithm to the first information.

5. The method of claim 1, wherein the at least one form is fileable with the federal government of the United States of America (USA) and is publicly available and includes at least one from among a Form NPORT, a Form NMFP, a Form ADV, and a Form 13F.

6. The method of claim 5, wherein the Form 13F includes at least one from among a Form 13F notice filing, a Form 13F combination report, and a Form 13F holdings report.

7. The method of claim 1, wherein the at least one proposed future transaction includes a transaction that relates to at least one derivative financial instrument.

8. The method of claim 7, wherein the at least one derivative financial instrument includes at least one from among a put option, a call option, a warrant, a swap, a futures contract, and an Equity Linked Notes instrument.

9. The method of claim 1, wherein when an amendment to the at least one form is filed, the method further includes revising the first knowledge graph based on the amendment.

10. A computing apparatus for forecasting market activity, the computing apparatus comprising:
a processor;
a memory; and
a communication interface coupled to each of the processor and the memory,
wherein the processor is configured to:
retrieve, from an internet website via the communication interface, first information that relates to at least one form that corresponds to a government filing;
generate, based on the first information, a first knowledge graph that relates to a first entity;
retrieve, from the memory, second information that relates to historical actions performed by at least one person that is associated with the first entity; and
forecast, based on the first knowledge graph and the second information, at least one proposed future transaction to be executed by the at least one person with respect to the first entity.

11. The computing apparatus of claim 10, wherein the processor is further configured to perform the forecasting by applying, to the first knowledge graph, at least one artificial intelligence (AI) algorithm that is trained by using the second information.

12. The computing apparatus of claim 10, wherein the processor is further configured to generate the first knowledge graph by using a Natural Language Processing (NLP) technique with respect to the at least one form.

13. The computing apparatus of claim 10, wherein the processor is further configured to generate the first knowledge graph by applying at least one predetermined tree search algorithm to the first information.

14. The computing apparatus of claim 10, wherein the at least one form is fileable with the federal government of the United States of America (USA) and is publicly available and includes at least one from among a Form NPORT, a Form NMFP, a Form ADV, and a Form 13F.

15. The computing apparatus of claim 14, wherein the Form 13F includes at least one from among a Form 13F notice filing, a Form 13F combination report, and a Form 13F holdings report.

16. The computing apparatus of claim 10, wherein the at least one proposed future transaction includes a transaction that relates to at least one derivative financial instrument.

17. The computing apparatus of claim 16, wherein the at least one derivative financial instrument includes at least one from among a put option, a call option, a warrant, a swap, a futures contract, and an Equity Linked Notes instrument.

18. The computing apparatus of claim 10, wherein when an amendment to the at least one form is filed, the processor is further configured to revise the first knowledge graph based on the amendment.

19. A non-transitory computer readable storage medium storing instructions for forecasting market activity, the storage medium comprising a second set of executable code which, when executed by a processor, causes the processor to:
retrieve, from an internet website, first information that relates to at least one form that corresponds to a government filing;
generate, based on the first information, a first knowledge graph that relates to a first entity;
retrieve, from a memory, second information that relates to historical actions performed by at least one person that is associated with the first entity; and
forecast, based on the first knowledge graph and the second information, at least one proposed future transaction to be executed by the at least one person with respect to the first entity.

20. The storage medium of claim 19, wherein when executed by the processor, the executable code further causes the processor to perform the forecasting by applying, to the first knowledge graph, at least one artificial intelligence (AI) algorithm that is trained by using the second information.
